(19) United States
(12) Patent Application Publication
(10) Pub. No.: US 2003/0177280 A1
(43) Pub. Date: Sep. 18, 2003

(54) Imbedded interrupt handler

(76) Inventors: Steve R. Webster, Raymond, NH (US); Lawrence E. Thompson, Tinley Park, IL (US)

Correspondence Address: Larry I. Golden, Square D Company, 1415 South Roselle Road, Palatine, IL, 60067, US

(21) Appl. No.: 10/096,354

(22) Filed: Mar. 12, 2002

(51) Int. Cl. G06F 9/46

(52) U.S. Cl. 709/318

(57) ABSTRACT

A system and method for triggering interrupt service routines from a main loop are disclosed. The system can be implemented in a computer readable medium that includes logic for: determining if a first flag has been set where the first flag is set in response to a first request for service and the first request for service is associated with a first message having a priority; determining if the first flag is valid including logic for returning to the main loop if the first flag is not valid; identifying the priority of the first message including logic for returning to the main loop; logic for setting a second flag if the priority of the first message is high; enabling a second request for service if the priority of the first message is high; and processing a first interrupt service routine if the priority of the first flag is high.

### TECHNICAL FIELD

The present invention is generally related to software for processing interrupts and associated interrupt service routines and, more particularly, is related to a system and method for using an imbedded interrupt handler for triggering interrupt service routines in programmable logic controllers.

### BACKGROUND

Programmable Logic Controllers (PLCs) provide a replacement for hard wired relay and timer logic circuits found in traditional control panels. PLCs offers flexibility in process control since its behavior is based on executing simple programmed logical instructions. Installation of PLCs is straight forward and amendments are easy to implement. Most modem PLCs offer internal functions such as timers, counters, shift registers, and special functions making sophisticated control possible using even the most modest PLC.

PLCs offer standard input and output interfaces that suit most process plant equipment and machinery. Standard input interfaces are available that permit direct connection to process transducers. Standard output interface circuitry will usually permit direct connection to contactors that energize process actuators such as motors, pumps and valves. Modern PLCs also have the ability to communicate with networks. A user may now monitor and control PLCs from a remote location.

PLCs monitor inputs from a process under control and possibly from the network. Based on the program being executed in memory, the PLC may energize appropriate outputs. The control operating system, which controls the behavior of the PLC, can be modified permitting the entire operation of the external hardware to be altered without the need to disconnect or reroute wiring.

The PLC control operating system may run in a main loop where the program executes from a first task to a last task and back to the first task. The loop may be interrupted to perform an auxiliary task that is outside of the main loop. The control operating system may also run multiple parallel processes (threads) that may not all share equal processor (CPU) time.

PLCs may have hardware interrupt inputs for fast response to external events. The interrupt sets a flag that is tested by the control operating system. The flag may call for an auxiliary task to be performed. The control operating system determines whether the flag applies to the PLC and determines the priority of the flag if the flag applies to the PLC. However, the auxiliary task is generally performed after the control operating system reaches the end of its predetermined cycle. The interrupt is generally unavailable to the PLC between the time it is triggered and the time the background task is initiated. Thus, undesirable delay is introduced into the system. Also, previously unaddressed deficiencies and inadequacies exist.

### SUMMARY

The present invention provides a system and method for triggering interrupt service routines from a main loop. In general terms, the system can be implemented in a computer readable medium where the computer readable medium includes the following logic: logic for determining if a first flag has been set where the first flag is set in response to a first request for service and the first request for service is associated with a first message and the message has a priority; logic for determining if the first flag is valid including logic for returning to the main loop if the first flag is not valid; logic for identifying the priority of the first message including logic for returning to the main loop if the priority is low; logic for setting a second flag if the priority of the first message is high; logic for enabling a second request for service if the priority of the first message is high; and, logic for processing a first interrupt service routine if the priority of the first flag is high.

The present invention can also be viewed as providing a method for triggering interrupt service routines from a main loop. In this regard, the method can be broadly summarized by the following steps; determining if a first flag has been set where the first flag has been set in response to a first request for service and the first request for service is associated with a first message and the message has a priority; determining if the first flag is valid including means for returning to the main loop if the first flag is not valid; identifying the priority of the first message including means for returning to the main loop if the priority is low; setting a second flag if the priority of the first message is high; enabling a second request for service if the priority of the first message is high; and processing a first interrupt service routine if the priority of the first flag is high.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon a clearly illustrating the principles of the present invention. Moreover, in the drawings, like reference numerals designate corresponding parts throughout the several views.

FIG. 1 is a block diagram of a control system including a programmable logic controller.

FIG. 2 is a block diagram of the programmable logic controller of FIG. 1. The programmable logic controller includes a control operating system. The control operating system includes an imbedded interrupt handler system.

FIGS. 3A and 3B show a flowchart of the control operating system and the imbedded interrupt handler system of FIG. 2.

### DETAILED DESCRIPTION

The present invention is generally related to software for processing interrupts and associated interrupt service routines and, more particularly, is related to a system and method for using an imbedded interrupt handler for triggering interrupt service routines in programmable logic controllers. The imbedded interrupt handler reduces the delay between an interrupt and the processing of the interrupt service routine associated with the interrupt.

A control operating system may run in a main loop in which a series of main tasks are performed in a sequential order. An interrupt is commonly used to provide a flag indicating that a task outside of the main loop must be performed. The flag may be included in a flags register. The task outside of the main loop is referred to as an interrupt service routine. In prior art programmable logic control operating systems, the interrupt service routine is processed after the last main task in the main loop. If the interrupt occurs in the early portions of the main loop, detrimental delay is introduced before the background task is processed. The detrimental delay, also referred to as “jitter,” may be between one hundred and several thousand microseconds. The interrupt may occur at any time during the main loop.

Interrupts maybe processor-generated, external hardware interrupts, and software interrupts. Common interrupts for programmable logic controllers include a discrete input module filter routine and an output module controller area network (CAN) interrupt. The first interrupt maybe received by any means such as the port B pin 4 bit position 0×10 hex of an STMicroelectronics microcontroller, such as Model No. ST72F521. The interrupt may be triggered by a high or low voltage signal at the input device. An interrupt vector table may be used to match interrupts with corresponding interrupt service routines.

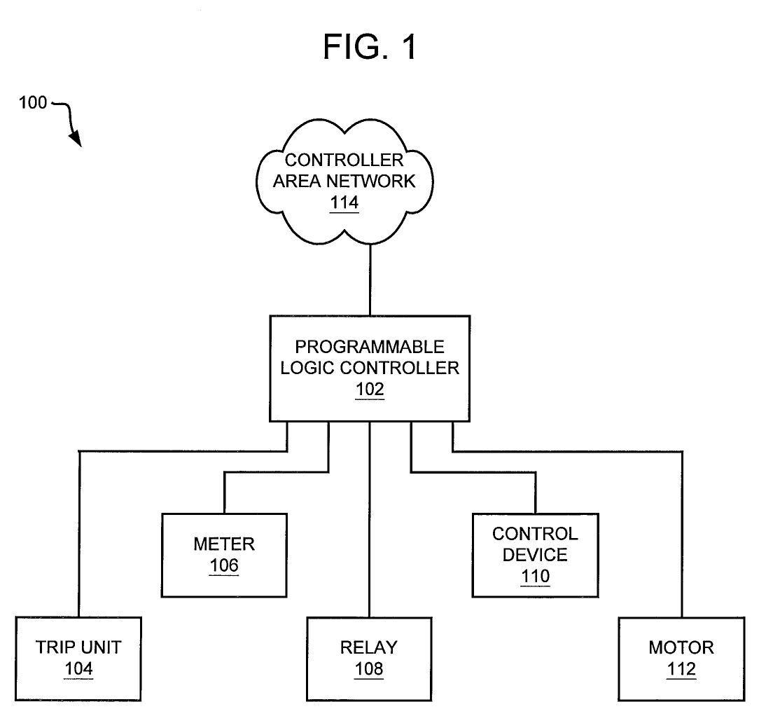

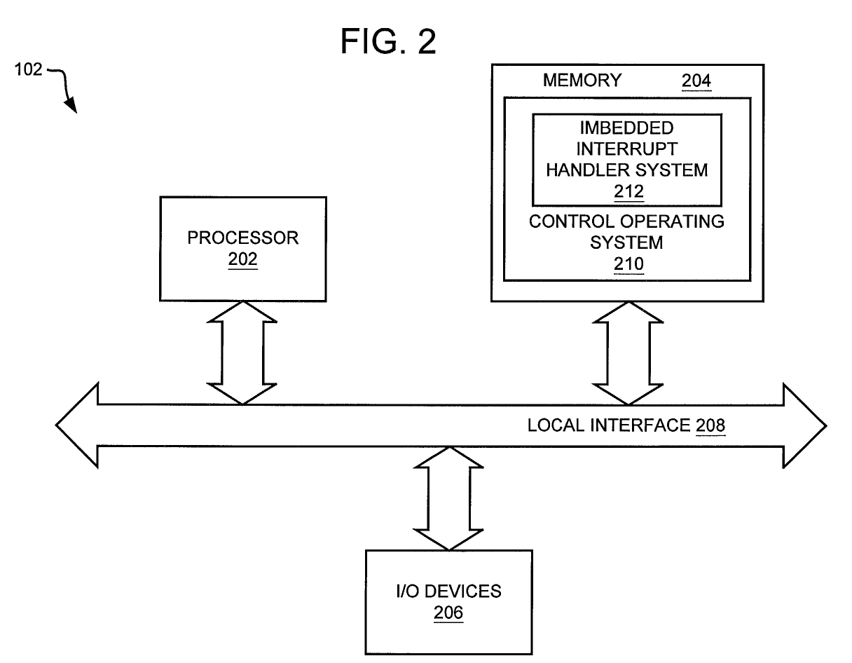

FIG. 1 is a block diagram of a control system 100 including a programmable logic controller 102. Programmable logic controller 102 may communicate with components such as a trip unit 104, a meter 106, a relay 108, a control device 110, a motor 112 and a control network. The control network may be a controller area network 114. The programmable logic controller 102 includes a control operating system 210 (FIG. 2). The control operating system 210 includes an imbedded interrupt handler system 212.

The imbedded interrupt handler system 212 can be implemented in software (e.g., firmware), hardware, or a combination thereof. In one embodiment, the imbedded interrupt handler system 212 is implemented in software, as an executable program, and is executed by a special or general purpose digital computer, such as a programmable logic controller, a personal computer (PC; IBM-compatible, Apple-compatible, or otherwise), workstation, minicomputer, and a mainframe computer. FIG. 2 is a block diagram of programmable logic controller 102. Programmable logic controller 102 includes the control operating system 210. The control operating system 210 includes the imbedded interrupt handler system 212. Though FIG. 2 shows the imbedded interrupt handler system 212 as a portion of the control operating system 210, the imbedded interrupt handler system 212 may also be considered a discrete program that works in conjunction with any operating system.

Generally, in terms of hardware architecture, as shown in FIG. 2, the programmable logic controller 102 includes a processor 202, memory 204, and one or more input and/or output (I/O) devices 206 (or peripherals) that are communicatively coupled via a local interface 208. The local interface 208 can be, for example, one or more buses or other wired or wireless connections, as is known in the art. The local interface 208 may have additional elements, which are omitted for simplicity, such as controllers, buffers (caches), drivers, repeaters, and receivers, to enable communications. Further, the local interface 208 may include address, control, and/or data connections to enable appropriate communications among the aforementioned components.

Processor 202 is a hardware device for executing software, particularly software stored in memory 204. Processor 202 can be any custom made or commercially available processor, a central processing unit (CPU), an auxiliary processor among several processors associated with the programmable logic controller 102, a semiconductor based microprocessor (in the form of a microchip or chip set), a macroprocessor, or generally any device for executing software instructions. Suitable commercially available microprocessors include: STMicroelectronics ST microprocessors PA-RISC series micorprocessors from Hewlett-Packard Company, 80×86 or Pentium series micorprocessors from Intel Corporation, PowerPC microprocessors from IBM, Sparc microprocessors from Sun Microsystems, Inc., and 68××× series microprocessors from Motorola Corporation.

Memory 204 may include one or more memory elements such as volatile memory elements (e.g., random access memory (RAM, such as DRAM, SRAM, SDRAM, etc.)) and nonvolatile memory elements (e.g., ROM, hard drive, tape, CDROM, etc.). Memory 204 may also incorporate electronic, magnetic, optical, and/or other types of storage media. Memory 204 may have a distributed architecture, where various components are situated remote from one another, but can be accessed by the processor 202.

The software in memory 204 may include one or more separate programs, each of which comprises an ordered listing of executable instructions for implementing logical functions. In the example of FIG. 2, the software in the memory 204 includes a control operating system 210. The control operating system 210 includes the imbedded interrupt handler system 212. Control operating system 210 may include portions of commercially available operating systems such as: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal data assistants (PDAs) (e.g., PalmOS available from Palm Computing, Inc., and Windows CE available from Microsoft Corporation). The control operating system 210 essentially controls the execution of other computer programs and provides scheduling, input-output control, file and data management, memory management, and communication control and related services.

The imbedded interrupt handler program 212 is a source program, executable program (object code), script, or any other entity comprising a set of instructions to be performed. When the imbedded interrupt handler program 212 is a source program, program 212 may be translated via a compiler, assembler, interpreter, or the like. The translator may, or may not, be included within the memory 204, so as to operate properly with the control operating system 210. Furthermore, the imbedded interrupt handler system 212 can be written as (a) an object oriented programming language, which has classes of data and methods, or (b) a procedure programming language, which has routines, subroutines, and/or functions, for example C, C++, Pascal, Basic, Fortran, Cobol, Perl, Java, and Ada. In one currently contemplated mode of practicing the invention, the imbedded interrupt handler system 212 is written in C.

The I/O devices 206 may include input devices, for example, digital input modules, contacts, keyboards, a mouse, scanners, microphones, etc. Furthermore, the I/O devices 206 may also include output devices, for example digital output modules, a printer, display, etc. Finally, the I/O devices 206 may further include devices that communicate both inputs and outputs, for instance a modulator/demodulator (modem; for accessing another device, system, or network), a radio frequency (RF) or other transceiver, a telephonic interface, a bridge, a router, and network connections, etc.

The software in the memory 204 may further include a basic input output system (BIOS) (omitted for simplicity). The BIOS is a set of essential software routines that initialize and test hardware at startup, start the control operating system 210, and support the transfer of data among the hardware devices. The BIOS is stored in ROM so that the BIOS can be executed when the programmable logic controller 102 is activated.

When the programmable logic controller 102 is in operation, the processor 202 is configured to execute software stored within the memory 204, to communicate data to and from the memory 204, and to generally control operations of the programmable logic controller 102 pursuant to the software. The imbedded interrupt handler system 212 and the control operating system 210, in whole or in part, but typically the latter, are read by the processor 202, perhaps buffered within the processor 202, and then executed.

When the imbedded interrupt handler system 212 is implemented in software, as is shown in FIG. 2, it should be noted that the imbedded interrupt handler system 212 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The imbedded interrupt handler system 212 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the imbedded interrupt handler system 212 is implemented in hardware, the imbedded interrupt handler system can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The imbedded interrupt handler addresses the problem of delays in processing from an interrupt to an interrupt service routine. The interrupt may be used to determine if new data is present. If new data is present, the interrupt service routine is called if further work is to be done. The interrupt pin is then free to receive new information. The imbedded interrupt handler sets a secondary interrupt inside the first interrupt. The secondary interrupt will execute the interrupt service routine after the first interrupt is completed.

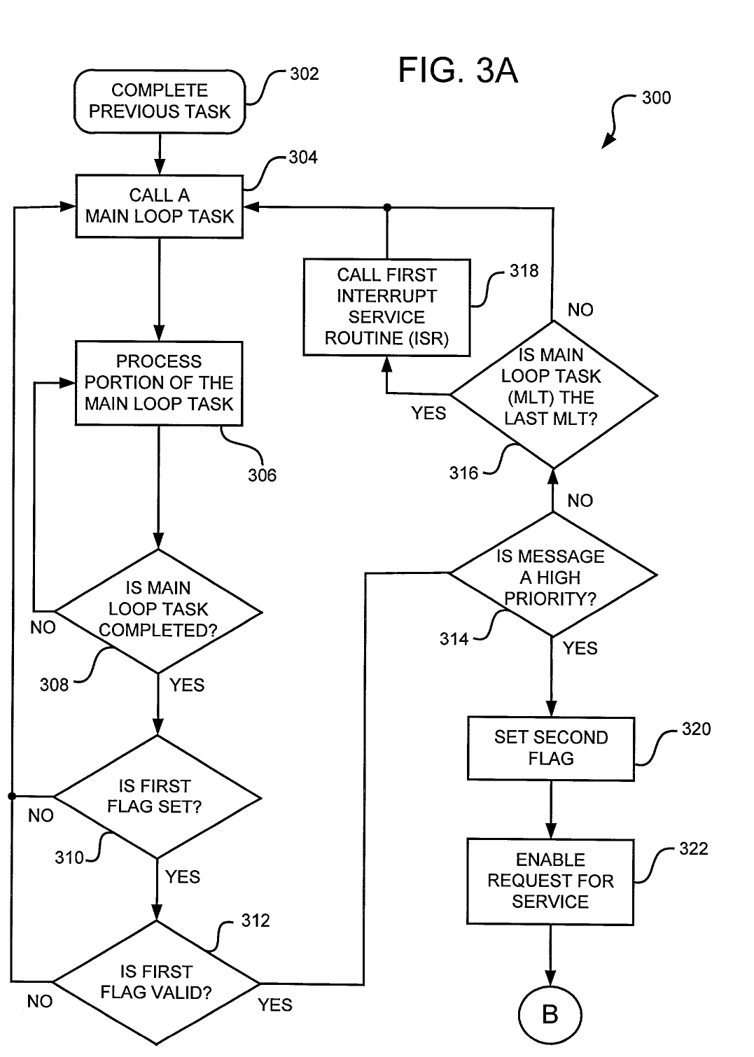

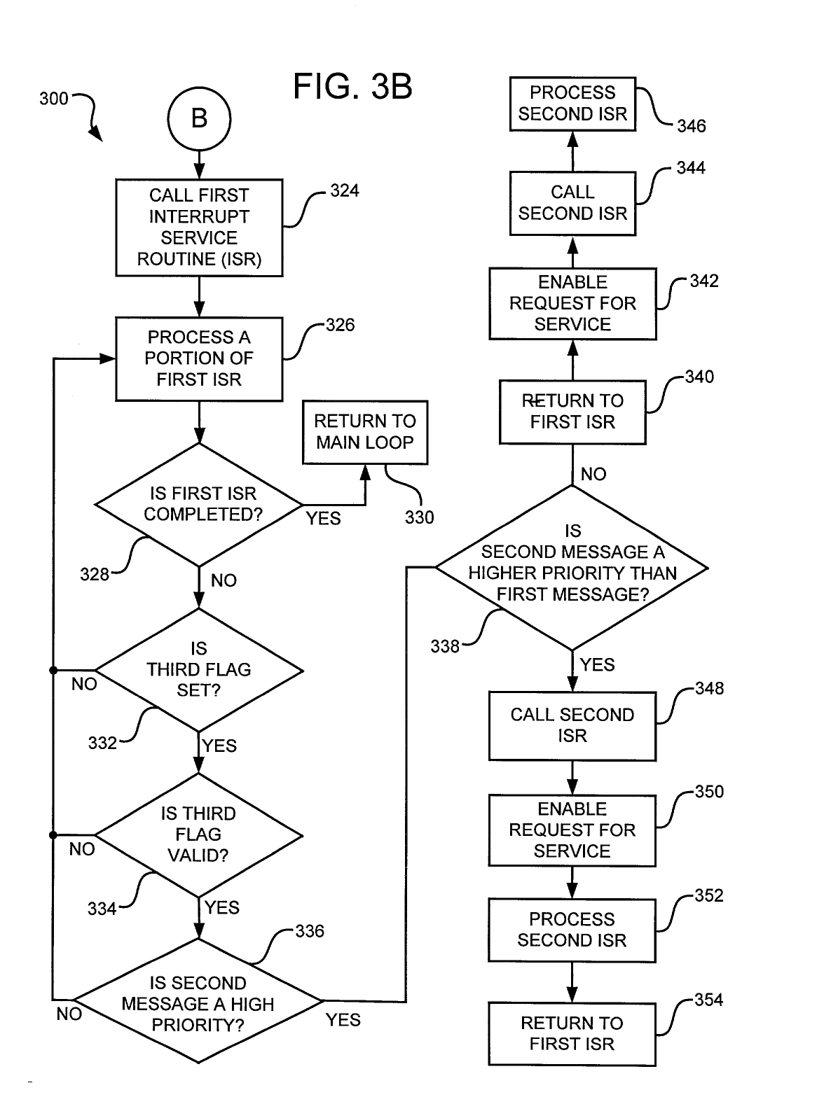

FIGS. 3A and 3B show a flowchart 300 of the control operating system 210 and the imbedded interrupt handler system 212 of FIG. 2. The control operating system 210 includes a main loop. The main loop includes blocks 304, 306, and 310. The control operating system 210 may be embodied in a computer readable medium. The main loop has a plurality of main loop tasks, including a first main loop task, a plurality of intermediate main loop tasks, and a last main loop task.

In block 302, the processor completes a previous task. The previous task may be any processor operation, such as, the processing of a main loop task, processing of an interrupt service routine, processing of the boot program, processing of a configuration program, or any other processing operation known to those having ordinary skill in the art.

In block 304, the control operating system 210 calls a main loop task. The main loop task may be a first, last or intermediate main loop task. The main loop task is any portion of the control operating system 210 that it is desirable to process prior to testing to determine whether a flag has been set. The main loop task is completed prior to the processor being interrupted. However, the size and the identity of the main loop task are not important as far as the invention is concerned. In fact, the main loop task may vary during the running of the control operating system 210 without affecting the operation of the invention.

In block 306, the control operating system 210 processes a portion of the main loop task. In block 308 the control operating system 210 returns to block 306 to process another portion of the main loop task, if the main loop task is not completed. If the main loop task is completed, the control operating system 210 moves to block 310.

In block 310, the control operating system 210 determines whether a first flag has been set. The flag may be a memory location. If a flag was set, then a first request for service has occurred. The first request for service may be received at an interrupt pin such as port pin 4 having a bit position 0×10 hex of an STMicroelectronics microprocessor. The first flag may be set in response to a controller area network (CAN) message. Those having ordinary skill in the art are familiar with the ST microprocessor and CAN messages. The CAN message may include a message frame having application data. The message frame may include an identifier and an arbitration field. A node, such as programmable logic controller 102, may use the identifier to determine whether the CAN message applies to the node. If the identifier passes an acceptance filter and/or matches an identifier in an identification table, the CAN message may be received by the node and an interrupt maybe generated for the processor 202. The identifier may also include an arbitration field. The identifier and its arbitration field may be used to determine the priority of the CAN message.

The first request for service generally disables the interrupt pin. The request for service may be set up in the manner outlined below:

| //set interrupt for ei3 | |
|---|---|
| ISPR1 &= ˜0x04; | //Set pin 4 for input interrupt |
| //If pin is low set interrupt for low level, if pin is high set interrupt | |
| for high level if (PBDR & 0x10){ | |
| MISCR2 = 0x40; | //high level interrupt trigger |
| } | |
| else { | |
| MISCR2 = 0x00; | //low level interrupt trigger |
| } | |

The first request for service is associated with a message and a first interrupt service routine. The message has a priority. The processor may manipulate the timing of when control operating system 210 goes to block 310 by changing the nature of the main loop task that is completed prior to the time the control operating system 210 determines whether a first flag has been set. If the control operating system 210 determines a first flag has not been set in block 310, the control operating system 210 returns to block 304 and calls another main loop task. If the control operating system 210 determines a first flag has been set in block 310, the control operating system 210 goes to block 312.

In block 312, the control operating system 210 determines if the first flag is valid. The criteria for determining whether a flag is valid may include, but is not limited to, whether the message is intended for processor 202, and whether the message has been received without error. If the control operating system 210 determines the first flag is not valid, the control operating system 210 returns to block 304 and calls another main loop task. If the control operating system 210 determines the flag is valid, the control operating system 210 goes to block 314.

In block 314, the control operating system 210 determines whether the first message has a high priority. The first message may have a high priority if it is related to an interrupt service routine that should be performed prior to going to a next main loop task. If the control operating system 210 determines the message does have a high priority, the control operating system 210 goes to block 320. If the control operating system 210 determines the message does not have a high priority, the control operating system 210 may return to block 304 and call another main loop task. In another embodiment, the control operating system 210 may go to block 316 prior to returning to the main loop in block 304.

In block 316, the control operating system 210 determines whether the last main loop task processed was the main loop's last task. If the control operating system 210 determines the last main loop task processed was the main loop's last task, the control operating system 210 may call a first interrupt service routine in block 318. The first interrupt service routine may be, but is not limited to, a discrete input module filter routine, and the output module controller area network interrupt. If the control operating system 210 determines the last main loop task processed was not the main loop's last task, the control operating system 210 returns to block 304 and calls another main loop task. If the control operating system 210 calls the first interrupt service routine in block 318, the control operating system 210 returns to block 304 after block 318 and calls another main loop task.

If the control operating system 210 goes to block 320 from block 314, the control operating system 210 sets a second flag in block 320. The second flag signals acts as an interrupt for the processor. After block 320, the control operating system 210 goes to block 322.

In block 322, the control operating system 210 enables a second request for service. The same port pin that received the first request for service may be enabled to receive the second request for service. An instruction such as “PBOR=0×10;//enable interrupt on port B pin 4,” may be included in the control operating system 210 in order to enable the second interrupt request.

In block 324, the control operating system 210 calls the first interrupt service routine. From block 322, the control operating system 210 goes to block 326. In block 326, the control operating system 210 processes a portion of the first interrupt service routine. In block 328 the control operating system 210 determines whether the first interrupt service routine is completed. If the control operating system 210 determines the first interrupt service routine is not completed, the control operating system 210 goes to block 332. If the control operating system 210 determines the first interrupt service routine is completed, the control operating system 210 goes to block 330 and returns to the main loop. The control operating system 210 may return to the main loop by returning to block 304 and calling another main loop task.

In block 332, the control operating system 210 determines if a third flag has been set during the processing of the first interrupt service routine. If a third flag has been set, then a second request for service has occurred. The second request for service is associated with a second message and a second interrupt service routine. The second message has a priority. The processor may manipulate the timing of when control operating system 210 goes to block 334 by changing the nature of the processing of the first interrupt service routine. The second request for service may be generated by an instruction in the first interrupt service routine. In the STMicroelectronics microprocessor, this may be accomplished because the port B pin is used for configuration setup. The pin is in a fixed state. The ST microprocessor may trigger an interrupt from a low or a high level. At power-up, the pin may be monitored for a high or low level and the second interrupt request can be set to trigger accordingly.

If the same interrupt port is used for several interrupt service routines, a character variable may be used to distinguish between the several interrupt service routines. The bits of the character variable may be used for different interrupt service routines. For example, bit0=1=first interrupt service routine needs service; and bit1=1=second interrupt service routine needs service.

If the control operating system 210 determines a third flag has not been set in block 332, the control operating system 210 returns to block 326 and continues to process the first interrupt service routine. If the control operating system 210 determines a third flag has been set in block 332, the control operating system 210 goes to block 334.

In block 334, the control operating system 210 determines if the third flag is valid. If the control operating system 210 determines the third flag is not valid, the control operating system 210 returns to block 326 and continues to process the first interrupt service routine. If the control operating system 210 determines the third flag is valid, the control operating system 210 goes to block 336.

In block 336, the control operating system 210 determines whether the second message has a high priority. If the control operating system 210 determines the second message does have a high priority, the control operating system 210 goes to block 338. If the control operating system 210 determines the second message does not have a high priority, the control operating system 210 returns to block 326 and continues to process the first interrupt service routine.

In block 338, the control operating system 210 determines whether the second message has a higher priority than the first message. The second message may have a higher priority if it is related to an interrupt service routine that should be performed prior to completing the first interrupt service routine. If the control operating system 210 determines the second message does have a higher priority, the control operating system 210 goes to block 348. If the control operating system 210 determines the second message does not have a higher priority than the first interrupt service routine, the control operating system 210 goes to block 340.

In block 340, the control operating system 210 returns to process the first interrupt service routine. The return may include returning to block 328. After returning to process the first interrupt service routine, the control operating system 210 goes to block 342. In block 342, the control operating system 210 enables a third request for service. The same port pin that received the first and second requests for service, may be enabled to receive the third request for service. After block 342, the control operating system 210 goes to block 344. In block 344, the control operating system 210 calls the second interrupt service routine. In block 346, the control operating system 210 processes the second interrupt service routine. After block 346, the control operating system may return to the main loop.

In block 348, the control operating system 210 calls the second interrupt service routine. After block 348, the control operating system 210 goes to block 350. In block 350, the control operating system 210 enables a third request for service. The same port pin that received the first and second requests for service may be enabled to receive the third request for service. After block 350, the control operating system 210 goes to block 352. In block 352, the control operating system 210 processes the second interrupt service routine. The control operating system 210 then goes to block 354. In block 354, the control operating system 210 returns to process the first interrupt service routine. After block 354, the control operating system may return to the main loop.

The description above provides for a second interrupt inside of a first interrupt. The secondary interrupt executes some interrupt service routines as soon as the first interrupt is completed. Thus asynchronicities between some interrupts and the execution of related interrupt service routines may be eliminated.

Flowchart 300 of FIGS. 3A and 3B shows the architecture, functionality, and operation of a possible implementation of the control operating system 210. The blocks represent modules, segments, and/or portions of code. The modules, segments, and/or portions of code include one or more executable instructions for implementing the specified logical function(s). In some implementations, the functions noted in the blocks may occur in a different order than that shown in FIGS. 3A and 3B. For example, two blocks shown in succession in FIGS. 3A and 3B may be executed concurrently or the blocks may sometimes be executed in another order, depending upon the functionality involved.

It should be emphasized that the above-described embodiments of the present invention, particularly, any “preferred” embodiments, are merely possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

At least the following is claimed:

1. A computer readable medium for triggering interrupt service routines from a main loop, the computer readable medium comprising:
logic for determining if a first flag has been set, the first flag being set in response to a first request for service, the first request for service being associated with a first message, the message having a priority;
logic for determining if the first flag is valid, the logic for determining if a first flag is valid including logic for returning to the main loop if the first flag is not valid;
logic for identifying the priority of the first message, the logic for identifying the priority of the first message flag including logic for returning to the main loop if the priority is low;
logic for setting a second flag if the priority of the first message is high;
logic for enabling a second request for service if the priority of the first message is high; and
logic for processing a first interrupt service routine if the priority of the first flag is high.

2. The computer readable medium of claim 1, where the first flag is a change of status in a memory location.

3. The computer readable medium of claim 1, where the first flag is set due to a first request for service.

4. The computer readable medium of claim 1, where the first flag is set due to the receipt of a signal at an interrupt pin.

5. The computer readable medium of claim 1, where the first flag is set in response to a controller area network message.

6. The computer readable medium of claim 1, where the first flag is set due to the receipt of a signal at an interrupt pin.

7. The computer readable medium of claim 1, where the first flag is set due to a first request for service, and the first request for service is set up using the following instructions:

| //set interrupt for ei3 | |
|---|---|
| ISPRi &= ˜0x04; | //Set pin 4 for input interrupt |
| //If pin is low set interrupt for low level, if pin is high set interrupt | |
| for high level if (PBDR & 0x10){ | |
| MISCR2 = 0x40; | //high level interrupt trigger |
| } | |
| else { | |
| MISCR2 = 0x00; | //low level interrupt trigger |
| } | |

8. The computer readable medium of claim 1, where the flag is valid if the message is intended for a programmable logic controller housing the computer readable medium.

9. The computer readable medium of claim 1, where the priority of the first message is high if the first message is related to an interrupt service routine that should be performed prior to the computer readable medium returning to the main loop.

10. The computer readable medium of claim 1, where the computer readable medium is being processed by a processor and the second flag interrupts the processor.

11. The computer readable medium of claim 1, where the first and second requests for service are received at the same pin.

12. The computer readable medium of claim 1, where the second request for service is enabled with the instruction,
PBOR=0×10;//enable interrupt on port B pin 4

13. The computer readable medium of claim 1, further comprising logic for determining if a third flag is set during the processing of the first interrupt service routine, the third flag being set in response to a second request for service, the second request for service being associated with a second message, the second message having a priority.

14. The computer readable medium of claim 1, further comprising logic for determining if the third flag is valid, the logic for determining if the third flag is valid including logic for returning to the first interrupt service routine if the third flag is not valid.

15. The computer readable medium of claim 1, further comprising logic for identifying the priority of the second message, the logic for identifying the priority of the second message including logic for returning to the first interrupt service routine if the priority of the second message is low.

16. The computer readable medium of claim 1, further comprising logic for calling a second interrupt service routine if the priority of the second message is high.

17. The computer readable medium of claim 1, further comprising logic for determining whether the second message has a higher priority than the first message.

18. A system for triggering interrupt service routines from a main loop, the system comprising:
means for determining if a first flag has been set, the first flag being set in response to a first request for service, the first request for service being associated with a first message, the message having a priority;
means for determining if the first flag is valid, the means for determining if a first flag is valid including means for returning to the main loop if the first flag is not valid;
means for identifying the priority of the first message, the means for identifying the priority of the first message flag including means for returning to the main loop if the priority is low;
means for setting a second flag if the priority of the first message is high;
means for enabling a second request for service if the priority of the first message is high; and
means for processing a first interrupt service routine if the priority of the first flag is high.

19. The system of claim 18, where the first flag is a change of status in a memory location.

20. The system of claim 18, where the first flag is set due to a first request for service.

21. The system of claim 18, where the first flag is set due to the receipt of a signal at an interrupt pin.

22. The system of claim 18, where the first flag is set in response to a controller area network message.

23. The system of claim 18, where the first flag is set due to the receipt of a signal at an interrupt pin.

24. The system of claim 18, where the first flag is set due to a first request for service, and the first request for service is set up using the following instructions:

| //set interrupt for ei3 | |
|---|---|
| ISPRi &= ˜0x04; | //Set pin 4 for input interrupt |
| //If pin is low set interrupt for low level, if pin is high set interrupt | |
| for high level if (PBDR & 0x10){ | |
| MISCR2 =0x40; | //high level interrupt trigger |
| } | |
| else { | |
| MJSCR2 =0x00; | 1/low level interrupt trigger |
| } | |

25. The system of claim 18, where the flag is valid if the message is intended for a programmable logic controller housing the system.

26. The system of claim 18, where the priority of the first message is high if the first message is related to an interrupt service routine that should be performed prior to the system returning to the main loop.

27. The system of claim 18, where the system is being processed by a processor and the second flag interrupts the processor.

28. The system of claim 18, where the first and second requests for service are received at the same pin.

29. The system of claim 18, where the second request for service is enabled with the instruction,
PBOR=0×10;//enable interrupt on port B pin 4

30. The system of claim 18, further comprising means for determining if a third flag is set during the processing of the first interrupt service routine, the third flag being set in response to a second request for service, the second request for service being associated with a second message, the second message having a priority.

31. The system of claim 18, further comprising means for determining if the third flag is valid, the means for determining if the third flag is valid including means for returning to the first interrupt service routine if the third flag is not valid.

32. The system of claim 18, further comprising means for identifying the priority of the second message, the means for identifying the priority of the second message including means for returning to the first interrupt service routine if the priority of the second flag is low.

33. The system of claim 18, further comprising means for calling a second interrupt service routine if the priority of the second message is high.

34. The system of claim 18, further comprising means for determining whether the second message has a higher priority than the first message.

35. A method for triggering interrupt service routines from a main loop, the method comprising the steps of:
determining if a first flag has been set, the first flag being set in response to a first request for service, the first request for service being associated with a first message, the message having a priority;
determining if the first flag is valid, the step of determining if a first flag is valid including a step of returning to the main loop if the first flag is not valid;
identifying the priority of the first message, the step of identifying the priority of the first message flag including the step of returning to the main loop if the priority is low;
setting a second flag if the priority of the first message is high;
enabling a second request for service if the priority of the first message is high; and
processing a first interrupt service routine if the priority of the first flag is high.

36. The method of claim 35, where the first flag is a change of status in a memory location.

37. The method of claim 35, where the first flag is set due to a first request for service.

38. The method of claim 35, where the first flag is set due to the receipt of a signal at an interrupt pin.

39. The method of claim 35, where the first flag is set in response to a controller area network message.

40. The method of claim 35, where the first flag is set due to the receipt of a signal at an interrupt pin.

41. The method of claim 35, where the first flag is set due to a first request for service, and the first request for service is set up using the following instructions:

| //set interrupt for ei3 | |
|---|---|
| ISPR1 &= ˜0x04; | //Set pin 4 for input interrupt |
| //If pin is low set interrupt for low level, if pin is high set interrupt | |
| for high level if (PBDR & 0x10){ | |
| MISCR2 = 0x40; | //high level interrupt trigger |
| } | |
| else { | |
| MISCR2 = 0x00; | //low level interrupt trigger |
| } | |

42. The method of claim 35, where the flag is valid if the message is intended for a programmable logic controller housing the system.

43. The method of claim 35, where the priority of the first message is high if the first message is related to an interrupt service routine that should be performed prior to the system returning to the main loop.

44. The method of claim 35, where the system is being processed by a processor and the second flag interrupts the processor.

45. The method of claim 35, where the first and second requests for service are received at the same pin.

46. The method of claim 35, where the second request for service is enabled with the instruction,
PBOR=0×10;//enable interrupt on port B pin 4

47. The method of claim 35, further comprising the step of determining if a third flag is set during the processing of the first interrupt service routine, the third flag being set in response to a second request for service, the second request for service being associated with a second message, the second message having a priority.

48. The method of claim 35, further comprising the step of determining if the third flag is valid, the step of determining if the third flag is valid including the step of returning to the first interrupt service routine if the third flag is not valid.

49. The method of claim 35, further comprising the step of identifying the priority of the second message, the step of identifying the priority of the second message including the step of returning to the first interrupt service routine if the priority of the second flag is low.

50. The method of claim 35, further comprising the step of calling a second interrupt service routine if the priority of the second message is high.

51. The method of claim 35, further comprising the step of determining whether the second message has a higher priority than the first message.

52. The method of claim 35, where the method is practiced in a programmable logic controller.
